(19) United States
(12) Patent Application Publication
(10) Pub. No.: US 2008/0080173 A1
(43) Pub. Date: Apr. 3, 2008

(54) LIGHTED GRAB BAR

(75) Inventors: Joshua A. Trimble, Franklin, IN (US); Sergio S. de Oliveira, Troy, OH (US)

Correspondence Address: BARNES & THORNBURG LLP, 11 SOUTH MERIDIAN, INDIANAPOLIS, IN, 46204, US

(73) Assignee: COSCO MANAGEMENT, INC., Wilmington, DE (US)

(21) Appl. No.: 11/866,874

(22) Filed: Oct. 3, 2007

Related U.S. Application Data
(60) Provisional application No. 60/827,989, filed on Oct. 3, 2006.

(51) Int. Cl. F21S 8/00

(52) U.S. Cl. 362/146

(57) ABSTRACT

A grab bar includes a handrail and first and second rail mounts coupled to the handrail. The grab bar also includes a light source associated with the handrail.

This application claims priority under 35 U.S.C. § 119(e) to U.S. Provisional Application Ser. No. 60/827,989, filed Oct. 3, 2006, which is expressly incorporated by reference herein.

### BACKGROUND

The present disclosure relates to lighting systems, and particularly, to lighting systems for wall-mounted fixtures. More particularly, the present disclosure is related to lighting systems for grab bars coupled to a wall surface.

### SUMMARY

According to the present disclosure, a lighted grab bar includes a handrail, a wall anchor system coupled to the handrail and adapted to be anchored to a wall to support the handrail in a fixed position relative to the wall, and a light-producing system. In an illustrative embodiment, the light-producing system is located in the handrail.

In an illustrative embodiment, a lighted grab bar includes a light-producing system comprising right and left-side lighting modules located in a chamber formed in a hollow handrail. The lighting modules provide light to illuminate the hollow handrail to assist a user in locating the grab bar in low-light conditions and also to provide auxiliary area lighting.

In illustrative embodiments, the right-side lighting module includes a first light and a first power source. The left-side lighting module includes a second light and a second power source. An on/off controller is provided to energize the first and second lights. In a first illustrative embodiment, the right-side lighting module is positioned to emit light through a light-emitting aperture formed in a right-side end of the hollow handrail and the left-side lighting module is positioned to emit light through a light-emitting aperture formed in a left-side end of the hollow handrail. In a second illustrative embodiment, at least a portion of the handrail is made of a translucent or transparent material so that light emitted by the lighting modules passes through the light-transmitting portion of the handrail to illuminate the handrail.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompany figures in which:

FIG. 1 is a perspective view of a first embodiment of a lighted grab bar in accordance with the present disclosure showing a hollow handrail supported in a fixed position relative to a wall by first and second rail mounts, a right-side lighting module packaged to fit in the hollow handrail and include a first light and a first power source, a left-side lighting module packaged to fit in the hollow handrail and include a second light and a second power source, and an on/off controller coupled to the left-side and right-side lighting modules;

FIG. 2 is an exploded perspective view of some of the components illustrated in FIG. 1 showing that the first light of the right-side lighting module includes a reflector cone, a light bulb, and a lens cap, the first power source includes a pair of batteries, the first anchor mount includes a mount plate, a pair of fasteners, an anti-rotation anchor pin, and a long set screw, and the first rail mount includes a short set screw;

FIG. 3 is an enlarged sectional view taken along line 3-3 of FIG. 1 showing the right-side lighting module housed in a chamber formed in the right end of the hollow handrail;

FIG. 4 is a perspective view of a lighted grab bar in accordance with a second embodiment of the present disclosure showing a translucent hollow handrail supported in a fixed position relative to a wall by first and second rail mounts, a right-side lighting module packaged to fit in the hollow handrail and configured to include a first light and a first power source, a left-side lighting module packaged to fit in the hollow handrail and configured to include a second light and a second power source, and an on/off controller coupled to the left-side and right-side lighting modules; and

FIG. 5 is an enlarged sectional view taken along line 5-5 of FIG. 1 showing the right-side lighting module housed in a chamber formed in the right-side of the hollow handrail.

### DETAILED DESCRIPTION

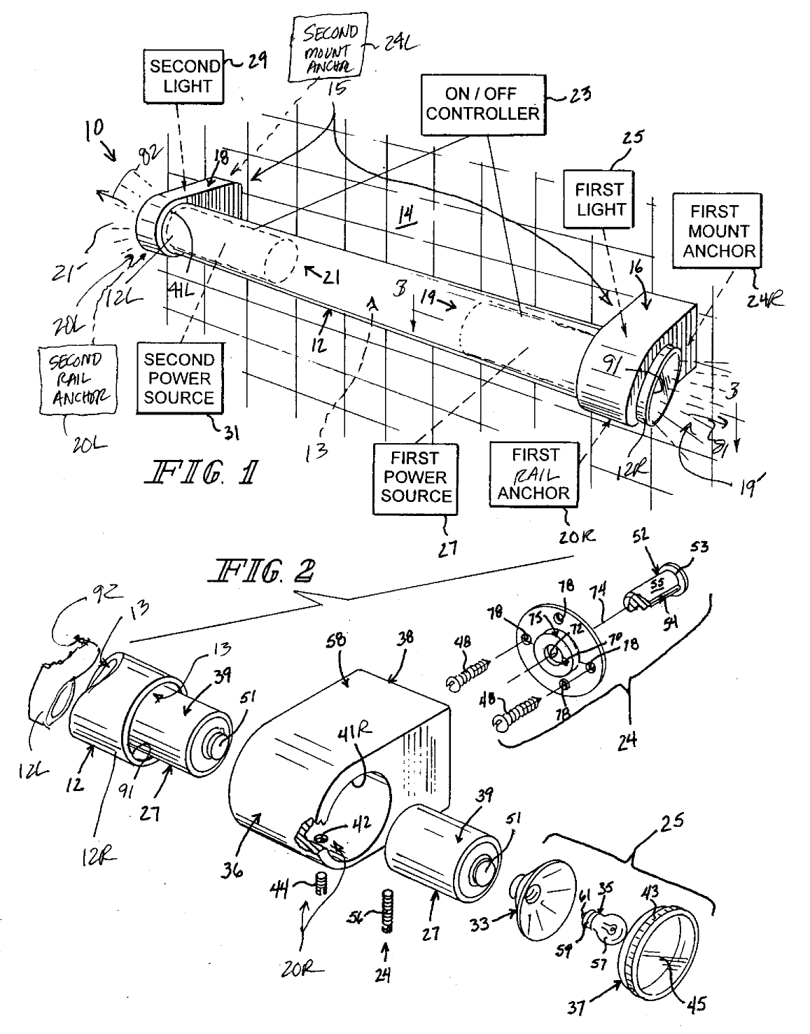

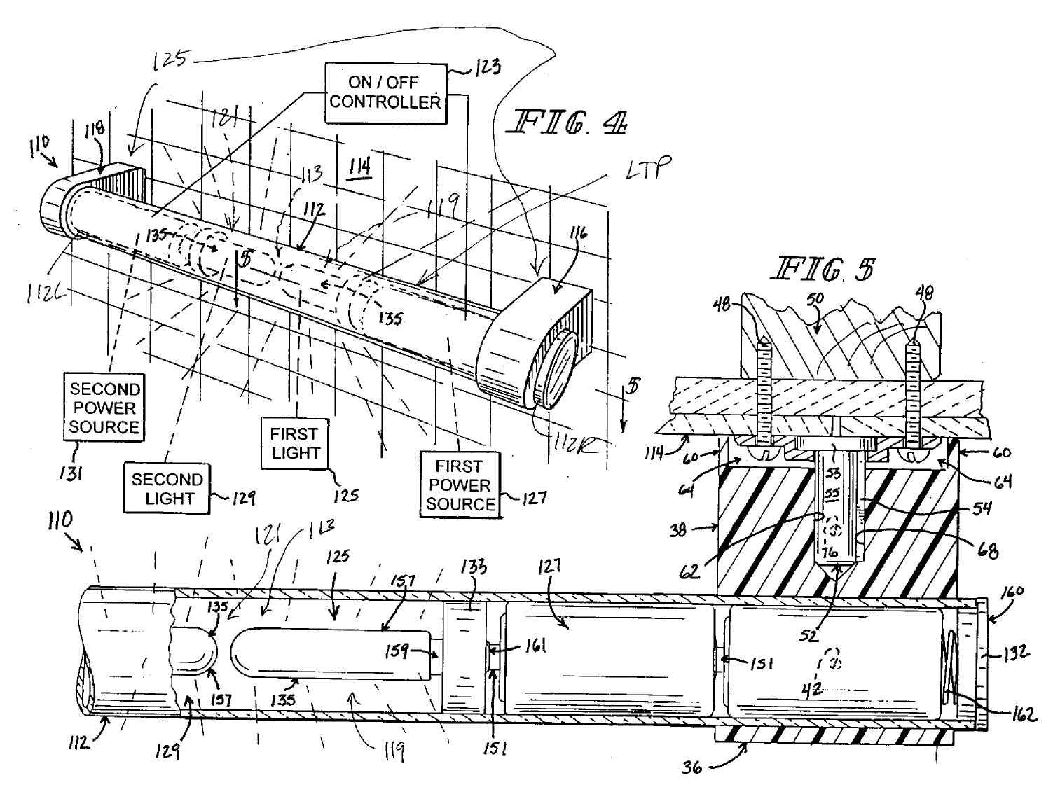

A lighted grab bar 10 includes a light for lighting a hollow handrail 12 supported in a fixed position relative to a wall 14 by a wall anchor system 15 comprising first and second rail mounts 16, 18, as shown in FIG. 1. Lighted grab bar 10 includes at least one lighting module configured and arranged to illuminate handrail 12 to allow a user to locate handrail 12 in low-light conditions and also to provide auxiliary area lighting. A lighted grab bar 10 in accordance with a first embodiment of the present disclosure is shown in FIGS. 1-3 and a lighted grab bar 110 in accordance with a second embodiment of the present disclosure is shown in FIGS. 4 and 5.

Lighted grab bar 10 includes a right-side lighting module 19 and a left-side lighting module 21 packaged to fit in hollow handrail 12, and an on/off controller 23 as suggested in FIG. 1. As suggested in FIG. 1, right-side lighting module 21 includes a first light 25 and a first power source 27. Left-side lighting module 21 includes a second light 29 and a second power source 31. Right-side lighting module 19 and left-side lighting module 21 are packaged to fit in hollow handrail 12 and arranged to lie in a spaced-apart relationship relative to one another as suggested in FIG. 1.

In an illustrative embodiment, right-side lighting module 19 and left-side lighting module 21 are configured to emit light from apertures 91, 92 formed in respective ends of handrail 12 as suggested in FIG. 1. Right-side lighting module 19 and left-side lighting module 21 are similar to one another in structure and function so that the description of right-side lighting module 19 applies to left-side lighting module 21 as well.

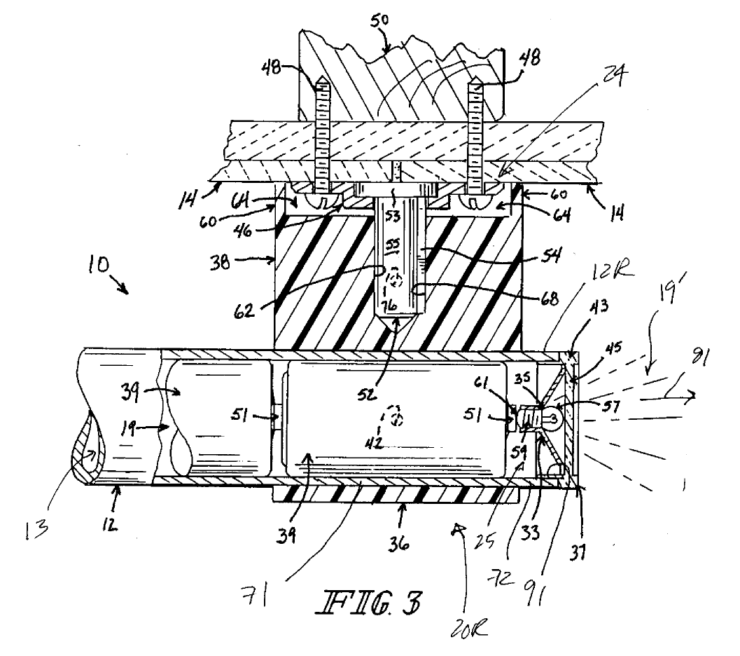

One illustrative embodiment of first light 25 and first power source 27 is shown in FIG. 2. First light 25 includes a reflector cone 33, a light bulb 35, and a tens cap 37. Reflector cone 33 may be made of aluminum, plastic, steel, or any other suitable material. Light bulb 35 includes a glass bulb 57 and a threaded metal socket 59 having a base contact 61. Light bulb 35 is an incandescent light bulb, but may be a light-emitting diode, a fluorescent light source, or any other suitable light-producing device. Lens cap 37 is configured to couple to a companion end of hollow handrail 12 as suggested in FIGS. 1 and 3 and includes a bezel 43 and a lens 45. Lens 45 may be made of plastics, glass, or any other suitable transparent or translucent material. First light 25 and reflector cone 33 cooperate to project light outwardly from the end of handrail 12 through aperture 12R and lens 45 of lens cap 37 as suggested in FIGS. 1 and 3.

In the illustrative embodiment, first power source 27 includes a pair of batteries 39. Batteries 39 may be any suitable dry-cell type battery sufficient to energize light bulb 35. Batteries 39 are positioned to lie in an end-to-end relationship so that a terminal 51 confronts base contact 61 to establish electrical communication therebetween.

As suggested in FIG. 1, on/off controller 23 is coupled to right-side lighting module 19 and left-side lighting module 21. On/off controller 23 may be a toggle switch, a touch-activated switch, a liquid level switch, a photocell, or any other suitable electrical controller. On/off controller 23 is configured to provide means for actuating first light 25 and second light 29 using batteries 39 or another suitable power source.

Wall anchor system 15 provides means for holding hollow handrail 12 in a fixed position relative to wall 14. In an illustrative embodiment, wall anchor system 15 includes first and second rail mounts 16, 18. It is within the scope of the present disclosure to support handrail 12 using one or more rail mounts.

First rail mount 16 and second rail mount 18 are similar to one another in structure and function so that the description of first rail mount 16 applies to second rail mount 18 as well. First rail mount 16 includes a sleeve 36 and a base 38 appended to sleeve 36 as shown in FIGS. 2 and 3. Sleeve 36 is annular in shape and slightly larger in diameter than handrail 12. Sleeve 36 is formed to include a passageway 41 configured to receive therein at least a portion of handrail 12 to hold handrail 12 in a fixed position. Sleeve 36 is slidable along the length of handrail 12 so that first rail mount 16 can be positioned by the user to accommodate alignment of first rail mount 16 with a stud 50.

A first mount anchor 24R is hidden in a hollow 64 formed in base 38 of first rail mount 16 and provided to anchor first rail mount 16 to stud 50 supporting wall 14, as suggested in FIG. 1 and shown in FIG. 3. First mount anchor 24R includes mount plate 46, fasteners 48, anti-rotation anchor pin 52, and a set screw 56 as shown in FIG. 2. First mount anchor 24 provides a rigid mounting structure to support first rail mount 16 and also blocks rotation of first rail mount 16 about axis 74 which extends through the center of first mount anchor 24.

As suggested in FIGS. 2 and 3, mount plate 46 is formed to include plate pin receiver 72, inner keyway 70, a recess 75, and apertures 78. Fasteners 48 extend through apertures 78 to couple mount plate 46 to stud 50. Anti-rotation anchor pin 52 is inserted through plate pin receiver 72 and inner keyway 70 to position pin 52 to extend away from stud 50. Recess 75 receives a platform 53 coupled to anti-rotation anchor pin 52 to couple pin 52 to plate 46 and retain platform 53 between mount plate 46 and stud 50.

Anti-rotation anchor pin 52 includes platform 53, a shaft 55, and a key 54 as shown in FIG. 2. As suggested in FIG. 3, anti-rotation anchor pin 52 is further formed to include an aperture 76 formed in shaft 55. When anti-rotation anchor pin 52 is received by base pin receiver 62, aperture 76 aligns with an aperture formed in base 38 to allow at least a portion of set screw 56 to enter aperture 76 to block lateral movement of first rail mount 16 along horizontal axis 74 extending through and along the length of anti-rotation anchor pin 52. Illustratively, set screw 56 is longer than a set screw 44 used in a first rail anchor 20.

Sleeve 36 is further formed to include an aperture 42 arranged to open into passageway 41 and configured to receive set screw 44 therein to confront handrail 12 to inhibit lateral and axial movement of handrail 12 relative to sleeve 36 as shown in FIG. 2. Set screw 44 and aperture 42 cooperate to define a first rail anchor 20R associated with first rail mount 16 and configured to provide means for anchoring first end 12R of handrail 12 in passageway 41R of first rail mount 16 as suggested in FIG. 1. Similarly, a second rail anchor 20L is associated with second rail mount 18 and configured to provide means for anchoring second end 12L of handrail 12 in a passageway 41L formed in second rail mount 18 as suggested in FIG. 1.

Base 38 includes a generally rectangular outer wall 58 having a lip 60 and a base pin receiver 62 as shown in FIG. 3. Rectangular wall 58 extends between sleeve 36 and lip 60. Rectangular wall 58 and lip 60 cooperate to define hollow 64 formed in base 38. Hollow 64 is configured to hide first mount anchor 24R when first rail mount 16 is coupled to first mount anchor 24R. Thus, first rail mount 16 also provides an aesthetic cover to hide at least a portion of first mount anchor 24k. Base pin receiver 62 is generally annular in shape and extends from sleeve 36 into hollow 64 as shown in FIG. 3. A second mount anchor 14L similar to first mount anchor 24R is associated with second rail mount 18 as suggested in FIG. 1.

Base pin receiver 62 is configured to receive anti-rotation anchor pin 52 included in first mount anchor 24R so that key 54 coupled to anti-rotation anchor pin 52 is received in an outer keyway 68 included in base pin receiver 62. Key 54, outer keyway 68, and inner keyway 70 cooperate to block rotation of first rail mount 16 relative to mount plate 46 about horizontal axis 74.

As suggested in FIG. 1, a lighted grab bar 10 includes a hollow handrail 12, a wall anchor system 15 coupled to hollow handrail 12 and adapted to be anchored to a wall 14 to support hollow handrail 12 in a fixed position relative to wall 14, and first and second lighting modules 19, 21. Each of first and second lighting modules 19, 21 are located in an interior region 13 formed in hollow handrail 12 and configured to generate light 19′ and 21′ as suggested in FIG. 1.

Hollow handrail 12 includes a first end 12R formed to include a light-emitting aperture 91 opening into interior region 13. First lighting module 19 is arranged to discharge light 19′ in a first direction 81 through light-emitting aperture 91 formed in first end 12R as suggested in FIGS. 1 and 3.

Hollow handrail 12 further includes an opposite second end 12L formed to include a light-emitting aperture 92 opening into interior region 13 as suggested in FIG. 2. Second lighting module 21 is located in interior region 13 of hollow handrail 12 and arranged to discharge light 21′ in a second direction 82 opposite to first direction 81 through light-emitting aperture 92 formed in second end 12L as suggested in FIG. 1.

Wall anchor system 15 includes a first rail anchor 20R coupled to first end 12R of hollow handrail 12 and a second rail anchor 20L coupled to the opposite second end 12L of hollow handrail 12. First rail mount 16 is formed to include a passageway 41R receiving a portion of first end 12R of hollow handrail 12 and a portion of first lighting module 19 therein. Second rail mount 18 is formed to include a passageway 41L receiving a portion of the opposite second end 12L of hollow handrail 12 and a portion of second lighting module 21 therein as suggested in FIG. 1.

Each of first and second lighting modules 19, 21 includes a power source and a light. Lights 25, 29 of first and second lighting modules 19, 21 are arranged to lie in spaced-apart relation to one another and the power sources 27, 31 are located in a space defined in interior region 13 of handrail 12 between the lights 25, 29 as suggested in FIG. 1.

First end 12R of hollow handrail 12 includes an inner section 71 located in passageway 41 formed in first rail mount 16 and an outer section 72 located outside of passageway 41 and formed to include light-emitting aperture 91 as suggested in FIG. 3. First lighting module 19 includes a battery 39 located in inner section 71 and a first light 24 located in outer section 72. First light 25 is associated with first end 12R of hollow handrail 12. First light 25 includes a light source 33, 35 situated in interior region 13 of hollow handrail 12 and a light-transmitting lens cap 37 coupled to first end 12R of hollow handrail 12 and configured to include lens 45.

Hollow handrail 12 is opaque. Light 19′ discharged from first light 25 exits interior region 13 of hollow handrail 12 through light-emitting aperture 91 formed in first end 12R of hollow handrail 12 and through light-transmitting lens cap 37 coupled to first end 120 of hollow handrail 12

Hollow handrail 12 includes a first end 12R formed to include a first light-emitting aperture 91 aligned with light 25 of first lighting module 19 and a second end 12L formed to include a second light-emitting aperture 92 aligned with light 29 of second lighting module 21. First end 12 of hollow handrail 12 is formed to include a first light-emitting aperture 91 opening into interior region 13 formed in hollow handrail 12. Second end 12L of hollow handrail 12 is formed to include a second light-emitting aperture 92 opening into interior region 13 formed in hollow handrail 12.

A light-producing system includes first and second lighting modules 19, 21 located in interior region 13 of hollow handrail 12 as suggested in FIG. 1. First lighting module 19 is configured to discharge light 19′ through first light-emitting aperture 91. Second lighting module 21 is located in interior region 13 of hollow handrail 12 and configured to discharge light 21′ through second light-emitting aperture 92.

In a second embodiment contemplated by this disclosure, a lighted grab bar 110 includes a light for lighting a hollow translucent handrail 112 supported in a fixed position relative to a wall 114 by first and second rail mounts 116, 118, as shown in FIG. 4. Lighted grab bar 10 includes at least one lighting module configured and arranged to illuminate an interior of handrail 112 to allow a user to locate handrail 112 in low-light conditions and also emits light from a chamber formed in handrail 112 through translucent or transparent material defining handrail 112, as suggested in FIG. 4, to provide auxiliary area lighting.

Lighted grab bar 110 includes a right-side lighting module 119 comprising a first light 125 and a first power source 127, a left-side lighting module 121 comprising a second light 129 and a second power source 131, and an on/off controller 123 as shown in FIG. 4. Right-side lighting module 119 and left-side lighting module 121 are packaged to fit in a chamber 113 formed in translucent handrail 112 and arranged to lie in a spaced-apart relationship relative to one another as suggested in FIGS. 4 and 5.

As suggested in FIG. 5, first light 125 includes a light bulb 135 energized by a pair of batteries 139 and a coupler 133. In an illustrative embodiment, light bulb 135 is an incandescent light bulb, but may be a light-emitting diode, a fluorescent light source, or any other suitable light-producing device. Light bulb 135 includes a glass bulb 157 and a threaded metal socket 159 having a base contact 161 adapted to be in electrical communication with a terminal 151 coupled to battery 139.

Coupler 133 is formed to include an aperture (not shown) to receive threaded metal socket 159. Coupler 133 is coupled in fixed relation to handrail 112 and arranged to lie in the interior of handrail 112. Threaded metal socket 159 is coupled to coupler 133 to hold light bulb 135 in a stationary position so that base contact 161 confronts terminal 151 to establish electrical communication therebetween.

A pair of batteries 139 are positioned to lie in an end-to-end relationship between coupler 133 and a plug 160. Plug 160 includes a helical spring 162 coupled to an end cap 132 and extending into the interior of handrail 112. End cap 132 couples to an end of handrail 112. Spring 162 is configured to urge batteries 139 toward coupler 133 so that terminal 151 is in electrical communication with base contact 161 of light bulb 135.

On/off controller 123 is coupled to right-side lighting module 119 and to left-side lighting module 121. On/off controller 123 may be a toggle switch, a touch-activated switch, a liquid level switch, a photocell, or any other suitable electrical controller as shown in FIG. 4. On/off controller 123 is configured to provide means for actuating first light 125 and second light 129 using batteries 139 or another suitable power source.

As suggested in FIG. 5, first rail mount 116 includes a first rail anchor 120 and a first mount anchor 124. First rail anchor 120 and first mount anchor 124 are similar in structure and function to first rail anchor 20R and first mount anchor 24R.

A lighted grab bar 110 includes a hollow handrail 112 including a light-transmitting portion (“LTP”) made of one of a translucent or transparent material and a wall anchor system 115. Wall anchor system 115 includes a first rail mount 116 coupled to a first end 12R of hollow handrail 112 and adapted to be anchored to a wall 114 to support hollow handrail 112 in a fixed position and a second rail mount 118 coupled to a second end 112L of hollow handrail 112 and adapted to be anchored to wall 114 to support hollow handrail 112 in the fixed position. Lighted grab bar 110 also includes a light-producing system including first and second lighting modules 119, 121 located in interior region 113 of hollow handrail 112 and configured to produce light visible through the light-transmitting portion of hollow handrail 112.

1. A lighted grab bar comprising
a hollow handrail,
a wall anchor system coupled to the hollow handrail and adapted to be anchored to a wall to support the hollow handrail in a fixed position relative to the wall, and
a first lighting module located in an interior region formed in the hollow handrail and configured to generate light.

2. The lighted grab bar of claim 1, wherein the hollow handrail includes a first end formed to include a light-emitting aperture opening into the interior region and the first lighting module is arranged to discharge light in a first direction through the light-emitting aperture formed in the first end.

3. The lighted grab bar of claim 2, wherein the hollow handrail further includes an opposite second end formed to include a light-emitting aperture opening into the interior region and further comprising a second lighting module located in the interior region of the hollow handrail and arranged to discharge light in a second direction opposite to the first direction through the light-emitting aperture formed in the second end.

4. The lighted grab bar of claim 3, wherein the wall anchor system includes a first rail mount coupled to the first end of the hollow handrail and a second rail mount coupled to the opposite second end of the hollow handrail, the first rail mount is formed to include a passageway receiving a portion of the first end of the hollow handrail and a portion of the first lighting module therein, and the second rail mount is formed to include a passageway receiving a portion of the opposite second end of the hollow handrail and a portion of the second lighting module therein.

5. The lighted grab bar of claim 3, wherein each of the first and second lighting modules includes a power source and a light and the lights of the first and second lighting modules are arranged to lie in spaced-apart relation to one another and the power sources are located in a space defined between the lights.

6. The lighted grab bar of claim 2, wherein the wall anchor system includes a first rail mount coupled to the first end of the hollow handrail and the first rail mount is formed to include a passageway receiving a portion of the first end of the hollow handrail and a portion of the first lighting module therein.

7. The lighted grab bar of claim 6, wherein the first end of the hollow handrail includes an inner section located in the passageway formed in the first rail mount and an outer section located outside of the passageway and formed to include the light-emitting aperture, and the first lighting module includes a battery located in the inner section and a light located in the outer section.

8. The lighted grab bar of claim 2, wherein the first lighting module includes a first light associated with the first end of the hollow handrail and the first light includes a light source situated in the interior region of the hollow handrail and a light-transmitting lens cap coupled to the first end of the hollow handrail.

9. The lighted grab bar of claim 8, wherein the hollow handrail is opaque and light discharged from the first light exits the interior region of the hollow handrail through the light-emitting aperture formed in the first end of the hollow handrail and through the light-transmitting lens cap coupled to the first end of the hollow handrail.

10. The lighted grab bar of claim 1, further comprising a second lighting module located in the interior region formed in the hollow handrail and configured to generate light.

11. The lighted grab bar of claim 10, wherein each of the first and second lighting modules includes a power source and a light and the lights of the first and second lighting modules are arranged to lie in spaced-apart relation to one another and the power sources are located in a space defined between the lights.

12. The lighted grab bar of claim 11, wherein the hollow handrail is opaque and includes a first end formed to include a first light-emitting aperture aligned with the light of the first lighting module and a second end formed to include a second light-emitting aperture aligned with the light of the second lighting module.

13. The lighted grab bar of claim 10, wherein each of the first and second lighting modules includes a power source and a light and the power sources of the first and second lighting module are arranged to lie in spaced-apart relation to one another and the lights are located in a space defined between the power sources.

14. The lighted grab bar of claim 13, wherein the hollow handrail is one of transparent and translucent and light emitted from the lights of the first and second lighting modules is visible to an observer observing an exterior portion of the hollow handrail.

15. The lighted grab bar of claim 1, wherein at least a light-transmitting portion of the hollow handrail is made of one of a transparent and translucent material so that light discharged by the first lighting module passes through the light-transmitting portion.

16. The lighted grab bar of claim 15, further comprising a second lighting module located in the interior region formed in the hollow handrail and configured to generate light.

17. A lighted grab bar comprising
a hollow handrail made of an opaque material,
a wall anchor system including a first rail mount coupled to a first end of hollow handrail and adapted to be anchored to a wall to support the hollow handrail in a fixed position and a second rail mount coupled to a second end of the hollow handrail and adapted to be anchored to the wall to support the hollow handrail in the fixed position, the first end of the hollow handrail being formed to include a first light-emitting aperture opening into an interior region formed in the hollow handrail, and the second end of the hollow handrail being formed to include a second light-emitting aperture opening into the interior region formed in the hollow handrail, and
a light-producing system including a first lighting module located in the interior region of the hollow handrail and configured to discharge light through the first light-emitting aperture and a second lighting module located in the interior region of the hollow handrail and configured to discharge light through the second light-emitting aperture.

18. A lighted grab bar comprising
a hollow handrail including a light-transmitting portion made of one of a translucent or transparent material,
a wall anchor system including a first rail mount coupled to a first end of the hollow handrail and adapted to be anchored to a wall to support the hollow handrail in a fixed position and a second rail mount coupled to a second end of the hollow handrail and adapted to be anchored to the wall to support the hollow handrail in the fixed position, and
a lighting module located in the interior region of the hollow handrail and configured to produce light visible through the light-transmitting portion of the hollow handrail.
